(19) United States
(12) Patent Application Publication
(10) Pub. No.: US 2013/0041862 A1
(43) Pub. Date: Feb. 14, 2013

(54) METHOD AND SYSTEM FOR PROVIDING RECOMMENDATIONS IN A SOCIAL NETWORK

(71) Applicants: Xiwang Yang, Brooklyn, NY (US); Yang Guo, Princeton Junction, NJ (US); Yong Liu, Brooklyn, NY (US)

(72) Inventors: Xiwang Yang, Brooklyn, NY (US); Yang Guo, Princeton Junction, NJ (US); Yong Liu, Brooklyn, NY (US)

(73) Assignee: THOMSON LOICENSING, Issy de Moulineaux (FR)

(21) Appl. No.: 13/642,644

(22) PCT Filed: Apr. 18, 2011
(86) PCT No.: PCT/US11/00690

§ 371 Date: Oct. 22, 2012

Related U.S. Application Data
(60) Provisional application No. 61/343,158, filed on Apr. 23, 2010.

(51) Int. Cl. G06N 5/02

(52) U.S. Cl. 706/46

(57) ABSTRACT

A Bayesian Inference based recommendation system in a social network is provided. The method and system utilizes content ratings from a querying initiator's friends and their friends depending on the time to live (TTL) and other factors. Receiving users send to the querying initiator recommendation ratings from their friends and a conditional probability of distribution of the recommendation ratings given by the recommender's rooted at the friend. Once this information has been obtained from the friend/hopped friend network, the querying initiator's recommendation query engine constructs the QI's own rating response using the Bayesian Inference Network.

### CROSS REFERENCE TO RELATED APPLICATIONS

This application claims the benefit of U.S. Provisional Application Ser. No. 61/343,158 filed Apr. 23, 2010, which is incorporated by reference herein in its entirety.

### TECHNICAL FIELD

The present invention relates to Recommender systems in social networks. More particularly, it relates a Bayesian inference based Recommender system for social networks.

### BACKGROUND

Recommender systems enable users to quickly locate the interested items and have become an important tool to overcome the information overload problem. Recommender systems are usually classified into three categories: 1) content based recommendations; 2) Collaborative Filtering (CF) recommendations; and 3) hybrid approaches. Content-based recommendations rely on content descriptions, and match the content with the users preference. Collaborative Filtering (CF) recommendations use the opinions of a set of users to predict another user's interest. The recommendation scheme of the present invention falls into CF recommendation category.

Online social networks, such as FACEBOOK™, TWITTER™, YOUTUBE™, have become extremely popular and attract millions of users. Online social networks provide users novel ways to communicate, to share information, and to build virtual communities. Findings in the sociology and psychology fields indicate that human beings tend to associate and bond with similar others, so called homophily. Using social networks to improve CF recommendations is an ongoing effort.

Trust has been identified as an effective means to utilize social networks to improve recommendations' quality. Empirical studies have shown the correlation between trust and user similarity. Various techniques have been proposed to incorporate the trust into CF approaches. Typically, trust is a numerical value with larger value indicating higher level of trust.

Finally, a Bayesian approach has been employed in the past in recommendation systems. In one example, a Bayesian network is formed with a node corresponding to an item. The states of nodes correspond to the possible rating values. A learning algorithm searches over various model structures and converges to the best one.

According to an embodiment of the present invention, a node in Bayesian network is a user, where the structure of Bayesian network is governed by the underlying social network. As is known, social networks already have similar users connected to each other. The recommendation method of the present invention can be carried out in a distributed fashion thus being more scalable than known systems.

### SUMMARY

The Bayesian inference based recommendation, as described herein, uses conditional probability distribution to capture the similarity between users. Probability distribution carries rich information, and allows the present invention to employ Bayesian network inference to conduct multiple-hop inferences.

According to an implementation, the method for providing recommendations in a social network; includes the steps of receiving a query message from a querying initiator (QI) for content rating, forwarding query message to QI's neighbors, receiving recommendations ratings from QI's neighbors and/or neighbors friends, receiving conditional probability of distribution of recommendation ratings given by recommenders rooted at a friend, and constructing a QI rating response using a Bayesian Inference Network.

In a further implementation, the method for providing recommendations in a social network; includes the steps of determining whether the QI has rated requested content previously in response to the received query message, returning to the QI their rating when it has been determined the QI has previously rated the requested content; and terminating query message from QI.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a plan view of an example of a Recommendation Social Network to which the present invention may be applied;

FIG. 2 is a diagram of a Recommendation propagation tree according to an embodiment of the present invention;

FIG. 3 is an example of a user confidence level input interface according to an embodiment of the invention;

FIG. 4 is a graphical representation of the number of recommendations vs. the probability threshold, according to an embodiment of the invention;

FIG. 5 is a graphical representation of the mean absolute error (MAE) over the maximum probability threshold, according to an embodiment of the invention;

FIG. 6 is a graphical representation of the number of recommendations received over a neighborhood size in the CF, according to an embodiment of the invention; and

FIG. 7 is a graphical representation of the MAE in CF over the neighborhood size, according to an embodiment of the invention;

FIG. 8 is a graphical representation of the MAE over number of recommendations in the social network recommended and CF, according to an embodiment of the invention; and

FIG. 9 is a flow diagram of the method for using the Bayesian inference based recommendation in a social network according to an embodiment of the invention.

### DETAILED DESCRIPTION

The present principles are directed to recommendation systems, and more specifically to a Bayesian inference based recommendation system.

It will thus be appreciated that those skilled in the art will be able to devise various arrangements that, although not explicitly described or shown herein, embody the present invention and are included within its spirit and scope.

All examples and conditional language recited herein are intended for pedagogical purposes to aid the reader in understanding the present invention and the concepts contributed by the inventor(s) to furthering the art, and are to be construed as being without limitation to such specifically recited examples and conditions.

Moreover, all statements herein reciting principles, aspects, and embodiments of the present invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present invention as defined by such claims resides in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

### Bayesian Inference Based Recommendation

### Motivating Example

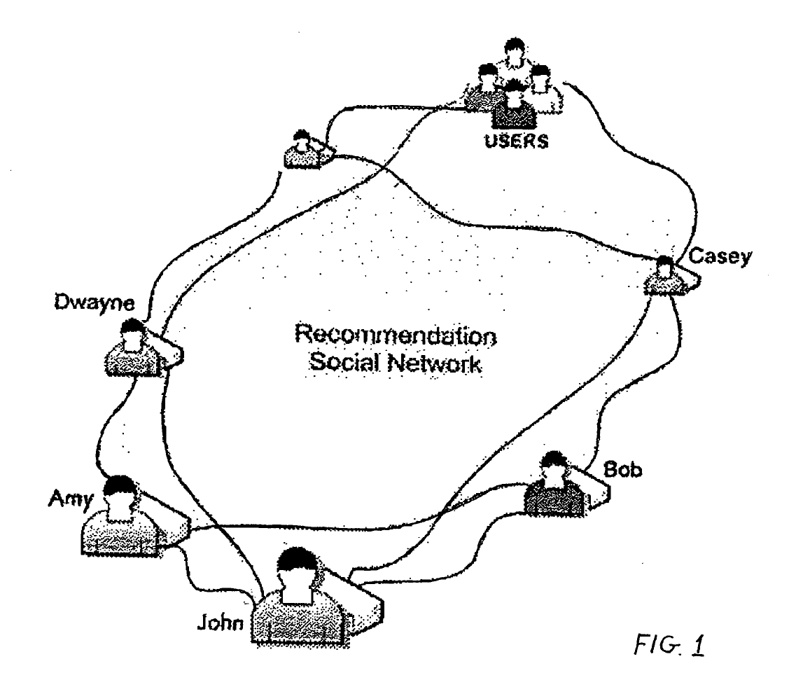

As shown in FIG. 1, users are connected in a social network by running social network agents on their own devices, e.g., PCs, mobile phones, set-top boxes, etc. After watching a movie, a user may choose to publish his/her recommendation/opinion to his/her friends. A user can also query his/her friends regarding the ratings of a specific movie. For instance, in FIG. 1, John is the friend of Amy, Bob, Casey, and Dwayne. Suppose John is thinking about if he should watch a new release. He issues a query to his friends. It turns out that Amy, Bob, and Casey have watched the movie, and return their ratings of five stars, three stars, and five stars, to John. Based on the returned ratings, John's local recommendation agent computes a recommendation rating that most likely reflects John's interest, and recommends the movie to John if the recommendation score is high.

The key problem in this example is how to estimate John's rating with low estimation errors. One naive approach is to recommend to John the average of his friends' ratings. The underlying assumption of this approach is that his friends' ratings are equally important to John. In reality, John's movies taste may be “closer” to that of Bob than to Amy and Casey. Intuitively, Bob's rating should carry more weight when estimating John's rating. One can introduce a “trust value” between friends and use the trust-weighted sum as the recommendation. However, it is challenging to represent the rating closeness between friends using one numerical value. In addition, it is difficult to propagate the trust values through a social network. A more refined approach is to look into the pairwise movie rating correlation between John and his friends in the past, and infer the “most probable” rating of John for the current movie. More specifically, if John and Amy have watched and rated a common set of movies in the past, the rating correlation between them can be measured by a set of conditional probabilities P (R_{J}|R_{A}) and P (R_{A}|R_{J}), where R_{J} and R_{A} are the random variables representing the ratings of John and Amy respectively. If Amy gives a score r_{A} for the new release, based on the rating history, the most probable rating of John for the movie can be estimated as

$${\hat{R}}_{j} ( {r}_{A} ) {=}^{Δ} {arg max}_{r} P ( {R}_{j} = r \vert {R}_{A} = {r}_{a} \vert )$$

Similarly, based on Bob and Casey's ratings, we can calculate two more estimates of John's rating and \tilde{R}ⱼ(r_{B}) and \tilde{R}ⱼ(r_{C}). Again we need to compute one recommendation for John by reconciling three different estimates. Ideally, we want to calculate the most probable rating of John conditional on three of his friends' ratings:

$${\hat{R}}_{J} ( {r}_{A} , {r}_{B} , {r}_{C} ) {=}^{Δ} {arg max}_{r} P ( {R}_{J} = r \vert {r}_{A} , {r}_{B} , {r}_{C} \vert )$$

where we introduce the abbreviation r_{{•}} for the event R_{{•}}=r_{{•}}. Unfortunately, it is hard to estimate the joint conditional distribution between John and all his friends. Instead, an embodiment of the present invention resorts to Bayesian network to reconstruct the joint conditional distribution based on the marginal conditional distributions between John and each of his friends. More specifically, the present invention construct a one-level Bayesian tree between John and his friends as follows: a) John is the root of the tree; b) each of John's friends is a direct child of John in the tree. Following the definition of Bayesian network, we essentially assume John's friends' ratings are independent with each other conditional on John's rating: {R_{A}⊥R_{B}⊥R_{C}|R_{J}}. In other words, we assume the rating discrepancies between John and his friends are independent. Under this assumption, we have:

P(r_{A},r_{B},r_{C}|r_{J})=P(r_{A}|r_{J})P(r_{B}|r_{J})P(r_{c}|r_{J})

Following the Bayesian rule, we can calculate the conditional probability of John's rating based on his friends' ratings as:

$$P ( {r}_{J} \vert {r}_{A} , {r}_{B} , {r}_{C} ) = \frac{P ( {r}_{A} , {r}_{B} , {r}_{C} \vert {r}_{J} ) P ( {r}_{J} )}{{\sum }_{r} P ( {r}_{A} , {r}_{B} , {r}_{C} \vert {R}_{J} = r ) P ( {R}_{J} = r )}$$

### Bayesian Inference Network

In more general settings, when a user wants a recommendation rating for movies, it may

happen that none of his direct friends have watched/rated the movie. In order to increase the chance of recommendation, an embodiment of the present invention allows a user to propagate his query through the social network and collect ratings from indirect friends who are several social hops away. Based on the collected ratings, we can construct a multi-level Bayesian inference network to estimate the most probable rating for the querying user.

### Framework

More specifically, the distributed recommendation system of an embodiment of the present invention works in the following framework.
Users are connected in a social network G=(V, E), where V is the set of users, E is the set of friendship links.
Each user shares his ratings with his direct friends;
Each pair of friends (u, v)εE measure their rating similarity by a set of conditional distributions P(u|v) and P(v|u), each of which is a user's rating distribution given the other user's rating;
A user sends out rating query for a movie to his direct friends in the social network G.
Upon receiving a query for a movie, a user returns its rating if they have rated the movies before, otherwise it will relay the query to its friends. In order to limit the range of query flooding, a query will be dropped after a predefined number of forwarding hops.
Recommendation agent calculates a score for the querying user based on returned ratings.

### Recommendation Propagation Tree

Let SεV be the user sending out the recommendation rating query for a movie. Let L*={LᵢεV, i=1, 2, . . . , k} be the indexed set of direct and remote friends of S who responds to the query. Social networks normally have rich connectivity. In an effort to avoid redundant query responses, we generate a unique id for each query. Each user in L*only responds to a query when it receives the query for the first time. We further assume that a query response will be returned to S along the reverse path of the query propagation path. As a result, the union of all query response paths is the shortest path tree from all recommenders in L* to the common root S.

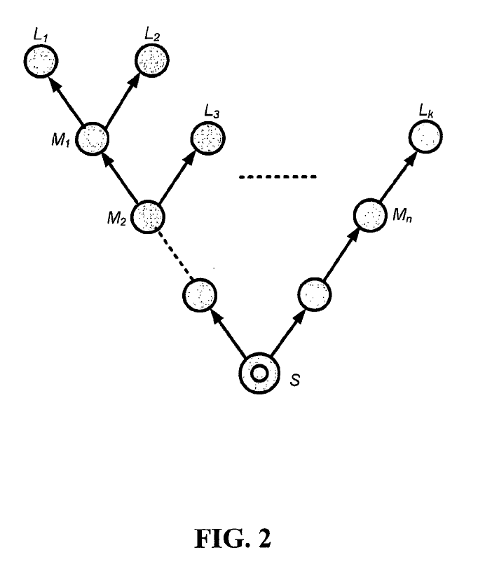

FIG. 2 illustrates an example of a (flipped) recommendation propagation tree with recommenders in L* as leaves and S as the root. The height of the tree is bounded by the scope of the query flooding. There are three types of users in a recommendation tree: 1) the querying initiator S; 2) recommendation responding users {L,}; and 3) intermediate users {Mᵢ}. A responding user, L, has a recommendation rating of r, for the queried movie, and transmits his rating to his parent user. An intermediate user sits on the path from responding users to the querying initiator. The intermediate user collects the recommendation information from his children users, aggregates the information, and relays the aggregated information to his parent user. Finally, given the structure of the recommendation propagation tree and the ratings on all leave users, the querying initiator computes the final recommendation rating.

### Bayesian Inference Network

In order to work with ratings from direct and remote friends, an embodiment of the invention resorts to general Bayesian network to calculate the most probable rating at the root. Thus, a Bayesian inference network is constructed out of the recommendation propagation tree.

Each user takes its next-hop node on the shortest path to the root as its only parent in the Bayesian inference network. In other words, we assume that a user's rating is independent of the ratings of non-descendant users in the propagation tree conditional on its parent's rating. Using the constructed Bayesian inference network, one can calculate the conditional probability of Pᵣ(Rₛ=s|R_{L}_{ᵢ}=rᵢ, l≦i≦K) based on the recommendation rating probability distribution and L, the marginal conditional probability distributions on all friend links in the propagation tree.

For any node m in the propagation tree, we define Cₘ as the set of its direct children. We further define Dₘ as the set of recommenders in the subtree rooted at m:

$${D}_{m} {=}^{Δ} \{ {L}_{i} ∈ {L}^{*} : {L}_{i} is the subtree rooted at m \} .$$

Recommendations generated by users in Dₘ are relayed by node m to the root. Obviously, we have Dₛ=L*. Due to the query forwarding protocol, if m itself is a recommender, it will not forward a query to its friends. Consequently, it will not forward recommendations generated by other recommenders, i.e., Dₘ={m}, if, mεL*

We define the probabilistic event of recommender Lᵢ gives rating rᵢ as

$$Φ ( {L}_{i} ) {=}^{Δ} \{ {R}_{Li} = {r}_{i} \} .$$

Then the event of the joint ratings of all recommenders under m can be composed as

$${Ψ}_{m} {=}^{Δ} \{ {R}_{Li} = {r}_{i} , {L}_{i} ∈ {D}_{m} \} = {⋂}_{{L}_{i} ∈ {D}_{m}} Φ ( {L}_{i} ) .$$

Our goal is to estimate P(R_{S}=s|Ψₛ). Following the Bayesian rule, we have

$$P ( {R}_{s} = s \vert Ψ s ) = \frac{P ( {Ψ}_{S} \vert {R}_{s} = s ) P ( {R}_{S} = s )}{{\sum }_{r = 1}^{N} P ( {Ψ}_{S} \vert {R}_{S} = r ) P ( {R}_{S} = r )}$$

It is sufficient to calculate P(Ψₛ|Rₛ=s). By definition, we have Dₛ=∪_{cεC}_{ₛ}D_{c} and •ₛ=∩_{cεCS}Ψ_{c}. Therefore we have

$$P ( {Ψ}_{S} \vert {R}_{S} = s ) = P ( {⋂}_{c ∈ {C}_{S}} {Ψ}_{c} \vert {R}_{S} = s ) = {\prod }_{c ∈ {C}_{S}} P ( {Ψ}_{c} \vert {R}_{S} = s ) ,$$

where the last equivalence is established by the conditional independence in the Bayesian network. If child c is a recommender, i.e., cεL*, then D_{c}={c}, and P(Ψ_{c}|R_{S}=s)=P(R_{c}=r_{c}|R_{S}=s), which can be directly obtained from the conditional probability between c and its parent S. If c is a relay node, i.e., cεL* then we have

$$\begin{matrix}P ( {Ψ}_{c} \vert {R}_{S} = s ) = {\sum }_{i = 1}^{N} P ( {Ψ}_{c} ⋂ \{ {R}_{c} = i \} \vert {R}_{S} = s ) \\ = {\sum }_{i = 1}^{N} P ( {Ψ}_{c} \vert {R}_{c} = i ) P ( {R}_{c} = i \vert {R}_{S} = s )\end{matrix} \qquad ( 1 )$$

where the last equivalence is established by the independence of the ratings of c's descendants in the Bayesian network with S conditional on c's rating. The last term P(R_{C}=i|R_{S}=s) in the last entry is readily available from the marginal conditional distributions between c and S. The first term Σᵢ₌ᵢⁿP(Ψ_{c}|{R_{c}=i}) can be recursively calculated following the similar process by going up one level in the Bayesian network.

### Most Probable Recommendation and Bayes MSE Recommendation

According to an embodiment of the invention, two recommendation metrics are employed, the most probable recommendation Ŝ^{MP}, and Bayes Mean Square Error estimator, Ŝ^{MSE}. Specifically,

$$\begin{matrix}{{S}^{⋒}}^{MP} {=}^{Δ} {arg max}_{1 \leq s \leq N} P ( {R}_{S} = s \vert Ψ s ) & ( 2 ) \\ {{S}^{⋒}}^{MSE} {=}^{Δ} E [ S \vert {Ψ}_{S} ] = {\sum }_{s = 1}^{N} sP ( {R}_{S} = s \vert {Ψ}_{s} ) & ( 3 )\end{matrix}$$

where N is the highest rating. Bayes MSE is also Minimum Mean Square Error estimator.

### Implementation Design

According to an embodiment of the invention, the recommendation social network agent comprises three key components:
a user-recommendation engine interface, which allows users to input their recommendations after watching movies, and query the recommendation engine
a learning module, whose main task is to communicate with direct friends, exchange recommendations, and construct probability distributions required by the Bayesian network inference. Specifically, the learning module estimates local user's recommendation probability distribution, and conditional distribution of friends' recommendation conditioned on local user's recommendation.
a recommendation query engine, which returns the inferenced recommendations based on available ratings inside the recommendation social network. The query is propagated to friends, who may relay the query to their own friends. The available recommendations propagate back to the query initiator along the reverse path. Bayesian network based inference is conducted in a distributed fashion to compute the recommendation score for the querying user.

Below is a description of an implementation of the learning module and the protocol employed in the recommendation engine, according to an embodiment of the invention.

### Learning Friends

Individual users are required to estimate their own recommendation rating probability distribution, and their direct friends' recommendation rating probability conditioned on their own ratings. Accordingly, learning module maintains a database that stores the following counters: {nᵢ} and {nⱼ^{T},i}. nᵢ is the number of occurrences of rating i made by local user, and n_{j,i}^{T} is the number of occurrences of rating j made by friend T while local user gives rating i, where i, j=1, 2, - - - , N, and N is the highest rating. A frequency based approach is then used to estimate the distribution. P(i)=nᵢ/Σᵢ₌₁^{N}nᵢ, and. P^{T}(j|i)=n_{j,i}^{T}/Σⱼ₌₁^{N}n_{j,i}^{T}. Note that the frequency based estimation is maximum likelihood estimator (MLE).

How to update these counters are described next. All counters are initialized to be zero. When user S makes a recommendation of {movie_id,s} through user-recommendation engine interface, the learning module stores the recommendation pair into the recommendation table. The counter nₛ is increased by one. The learning module then sends {S, movie_id, s} to all direct friends. Assume the friend T receives the message. T's learning module conducts a lookup service at its recommendation table, and determines if T has already rated the same movie. If T never rated the movie, the message is discarded without further action. If T rated the movie with rating t, the learning module of user T increases the counter n_{s J}^{S} by one. In addition, T sends back a message of (T, movie_id, t) to user S. The purpose of this message is to allow user S to update its conditional counter accordingly.

Inference Recommendation by Querying Social Network Assume user S queries the recommendation engine. The recommendation engine sends the query messages to neighbors over the social network. A query message is 3-tuple of [sequence-id, movie-id, TTL]. The sequence-id is a unique id identifying this query message. For instance, the id can be created by hashing the movie-id together with querying user's own social network id. The movie-id identifies the interested movie for which the recommendation is sought after. TTL, or time-to-live, defines the search scope of the query. If the query message reaches the TTL (i.e., the TTL times out), the query message is dropped without further relaying.

Upon receiving a query message, a user first checks if he/she has already rated the interested movie. If yes, the movie rating is returned back to the user from which the query message is received. The query message is dropped without further forwarding. If the receiving user has not rated the movie, and the number of forwarding times of the query message is less than the TTL (time-to-live), the query message is forwarded to receiving user's neighbors, except the one from which the query message is received. Finally, if the query message reaches the TTL, it will be dropped. The receiving user sends a DROP message back to the user from which the query is received, indicating that the query has been dropped without recommendation.

The social network may have loops, and a user may receive the same query message from different neighbors. To simplify the inference, the receiving user only responds to the first query message, and sends DROP messages to all other sending users.

If a user is an intermediate user, he/she starts to wait for the responses after forwarding the query message to the direct friends. One response shall be received from each friend to which the query message has been forwarded. The response falls into three categories: a DROP message, a recommendation rating given by the friend, or the conditional probability distributions of the recommendation ratings given by the recommenders rooted at the friend, and conditioned on the N possible ratings of the friend. Once the user receives all responses, he/she starts to construct his/her own response, the conditional probability distributions of all received recommendation ratings conditioned on his/her possible N ratings, using the algorithm as described in the above discussion of the Bayesian inference network. The response is then delivered to the user from which the query message is received. Finally, after user S receives all responses, he/she computes the personalized recommendation rating as described above (Section 2.2.3 and Section 2.2.4.)

Coping with Cold Start and Rating Sparseness Using Maximum a Posteriori (Map) Estimation

Learning modules use the common ratings to construct probability distributions. Frequency based approach is used in probability estimation. The frequency based approach can be shown as maximum likelihood estimator (MLE). The estimation may be inaccurate, however, due to the small number of common ratings. In addition, a newly joined user has not made any ratings, thus friends cannot construct conditional probabilities against the new user. These so-called rating sparseness issue and cold start issue have baffled collaborative filtering (CF) based recommendation approaches.

Social network offers a new venue that allows users to help tackle the above issues. In the context of social network, a new user is likely to know his/her friends, and have general feelings/opinions about them. A new user can give a guideline on how the conditional probability distribution should look like. For instance, the new user may indicate to the recommendation engine that with likelihood of eight (in the range from one to ten), his rating is the same as a neighbor, and with likelihood of five, the recommendation rating is probably off by one, and so on and so forth. With this information, the recommendation engine can construct informative prior distributions for a new user's neighbors. Similarly, the neighbors of a new user can apply the same principle and construct the informative prior distributions for the new user. The prior distribution attributes uncertainty to the probability distribution. As the actual recommendation ratings accumulates over the time, the prior distribution is rectified by the actual ratings to reflect. the true similarity between two users. Below we describe a MAP based probability estimation.

Let p=[p₁, p₂, . . . , pₙ] be an n-state discrete probity density function (p.d.f.) and x={xᵢ}, i=1, 2, . . . n be the number of observed samples for each state. If g(p) is the prior distribution of p, the MAP estimate, p^{MAP}, is defined as the distribution that maximizes the posterior p.d.f. of p.

$${p}^{MAP} = arg {max g}_{p} ( p \vert x ) = {arg max f ( x \vert p ) g ( p )}_{p} \qquad ( 4 )$$

where f(x|p) is the probability of x given p.

We select the Dirichlet distribution as the prior distribution. The Dirichlet distribution is conjugate to discrete probability distribution which simplifies the derivation. The Dirichlet distribution is defined as

$$f ( {p}_{1} , {p}_{2} , … , {p}_{n - 1 ;} {α}_{1} , {α}_{2} , … , {α}_{n - 1} , {α}_{n} ) = \frac{1}{Z} {\prod }_{i = 1}^{n} {P}_{i}^{{α}_{i}^{- 1}} ,$$

where αᵢ>0, pᵢ>0, Σᵢ₌₁ⁿ⁻¹pᵢ<1, pₙ=1−Σᵢ₌₁ⁿ⁻¹pᵢ, and Z is normalization constant,

$$Z = \frac{{\prod }_{i = 1}^{n} Γ ( {α}_{i} )}{Γ ( {\sum }_{i = 1}^{n} {α}_{i} )} ( Γ ( . )$$

is gamma function). The Dirichlet distribution defines the distribution of p given parameters {αᵢ}. Therefore

$$\begin{matrix}{P}_{r} ( x \vert p ) g ( p ) = {\prod }_{i = 1}^{n} {p}_{i}^{{x}_{i}} \cdot \frac{1}{Z} {\prod }_{j = 1}^{n} {p}_{j}^{{α}_{j - 1}} \\ = \frac{1}{Z} {\prod }_{i = 1}^{n} {p}_{i}^{{x}_{i}^{+} {α}_{i}^{- 1}}\end{matrix} \qquad ( 5 )$$

### Solve (4), we get:

$${p}_{i}^{MAP} = \frac{{x}_{i} + {α}_{i} - 1}{{\sum }_{i = 1}^{n} ( {x}_{i} + {α}_{i} - 1 )} \qquad ( 6 )$$

Interestingly, at the beginning with no observations/samples,

$${p}_{i}^{MAP} = \frac{{α}_{i} - 1}{{\sum }_{i = 1}^{n} ( {α}_{i} - 1 )} . \qquad ( 7 )$$

Parameters {αᵢ} shall be set based on users' inputs. The value of Σᵢ₌₁ⁿ(αi−1) plays an important role in determining how fast the impact of prior distribution diminishes as the number of available samples increases.

### Setting Parameters of Prior Distribution

The parameters of Prior Dirichlet Distribution parameters, fed have to be set in such a way that: (i) they reflect the confidence level of a user toward the neighbor in terms of the similarity of their taste/opinion towards movies; and (ii) the impact of Prior distribution should diminish as more samples are collected.

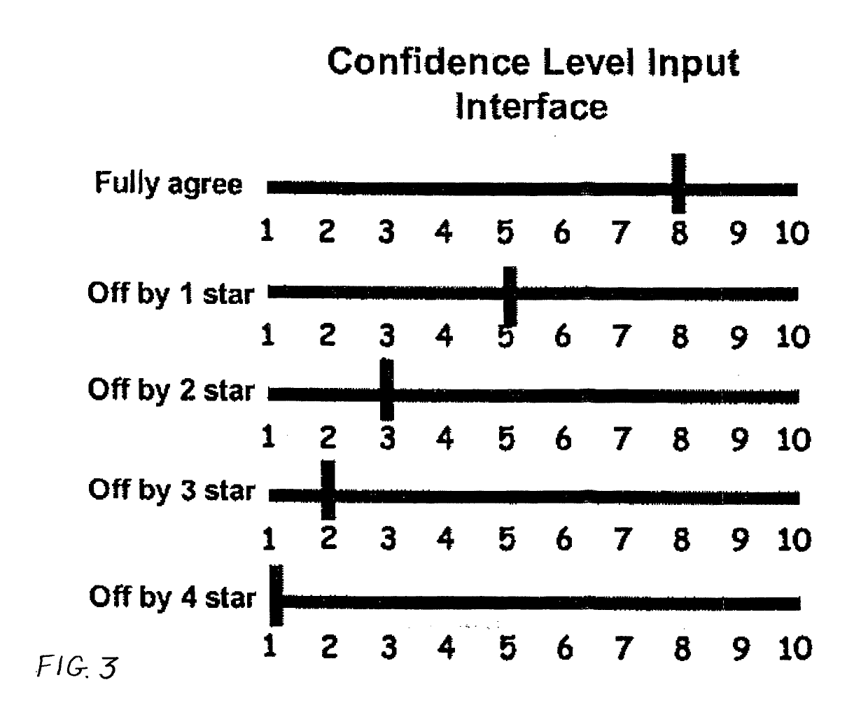

The confidence level of a user towards the neighbors can be collected using a simple GUI interface as depicted in FIG. 3. The users move the sliding bar to select the confidence level. Confidence level ranges from one to ten: the higher the number is, the more similar two users are. There are N−1 confidence-level bars, where N is the highest rating. Denote by {cᵢ}ᵢ₌₀^{N-1} the user's confidence levels. The first bar sets the confidence level of cₒ for two users fully agreeing with each other. The i-th bar set the confidence level of cᵢ for the ratings off by i stars.

Now we describe how to set the Dirichlet parameters. Suppose user X has a neighbor user Y. User X and user Y's recommendation ratings are denoted by x and y, respectively. User X sets up the parameters of N conditional probability distributions,

p(y=h|x=l), l, h=1, 2, . . . , N, as follows:

$$p ( y = h \vert x = l ) = \{ \begin{matrix}\frac{{c}_{o}}{{\sum }_{i = 1}^{N} {c}_{\vert l - i \vert} / 2 + {c}_{o}} , & if h = l \\ \frac{{c}_{\vert l - h \vert / 2}}{{\sum }_{i = 1}^{N} {c}_{\vert l - i \vert} / 2 + {c}_{o}} , & if h \neq l\end{matrix}$$

Except for c₀, confidence levels are divided by two in computing probability because offset by i stars can either be greater than the conditional value l by i stars, or smaller than the conditional value l by i stars.

The parameters of Prior Dirichlet distribution for p(y|x=l). πₕ^{l}=K·p(y=h|x=l)+1, where K=Σₕ₌ₗ^{N}(αₕ^{l}−1), are denoted by {αᵢ^{l}, i=1, 2, . . . , N}. The value of K is selected to properly reflect the influence of Prior distribution vs. actual samples.

### Data Set and Social Network Construction

For performance evaluation of the method of the present invention, we select the MovieLens dataset with about 1 million ratings for 3900 movies by 6040 users. The same dataset has been used in other studies, and the number of ratings, movies, and users are manageable yet rich enough to evaluate our algorithm. The ratings are on the numerical five start scale, where one and two stars represent negative ratings, three stars represents ambivalence rating, and four, five stars represent positive ratings. Unless indicated otherwise, the dataset. is divided into two parts: first. 70% of the user ratings is used for training purpose—to construct the social network and to estimate the rating probability and conditional probability distributions at individual users. The leftover 30% data is used for testing/evaluation

An artificial social network is constructed using the training data set. Sociology and psychology study show that the similar users have the tendency to associate with each other. We use the Pearson correlation coefficient to measure two users' similarity. Pearson correlation coefficient, between user u and user w is:

$${S}_{r} ( u , w ) = \frac{{\sum }_{i ∈ Ic} ( {r}_{ui} - \overline{{r}_{y}} ) ( {r}_{wi} - \overline{{r}_{w}} )}{\sqrt{{\sum }_{i ∈ Ic} {( {r}_{ui} - \overline{{r}_{u}} )}^{2} {\sum }_{i ∈ Ic} {( {r}_{wi} - \overline{{r}_{w}} )}^{2}}} \qquad ( 8 )$$

where I_{C} is set of common ratings. Each user chooses to connect with ten users as his/her direct friend. These ten users are selected from a pool of 500 users (randomly selected out of the entire user population) with the highest Pearson correlation coefficient. Since a user may also be selected by other users as friend, the average number of friends, or the degree of a user in social network, is twenty. In addition, if the number of common ratings of two users is less than 20, these two users won't be friends in order to avoid randomness.

### Impact of Query Range, Probability Threshold, and Dynamic Probability Learning

In the following experiments we use most probable (MP) rating in selecting the recommendation rating, and the mean absolute error (MAE) to measure the recommendation accuracy. To avoid the computational error introduce by zero probability, we smooth the distribution by adding a small probability to all discrete probability. Using the Most Probable (MP) recommendation described in Equation (2) above, a recommendation has an associated probability. We set a probability threshold and only the recommendations whose probability is greater than the threshold are presented to the querying user. A recommendation with low probability is not trustworthy. As to be shown in the following experiment, the MAE of recommendations improves as the probability threshold increases.

In this experiment, we also look into the impact of dynamic probability learning. Specifically, the beginning 70% of the data set is used to training the probability distribution. Once the simulation of the remaining 30% testing data set starts, we allow the users to continuously update the probability distributions.

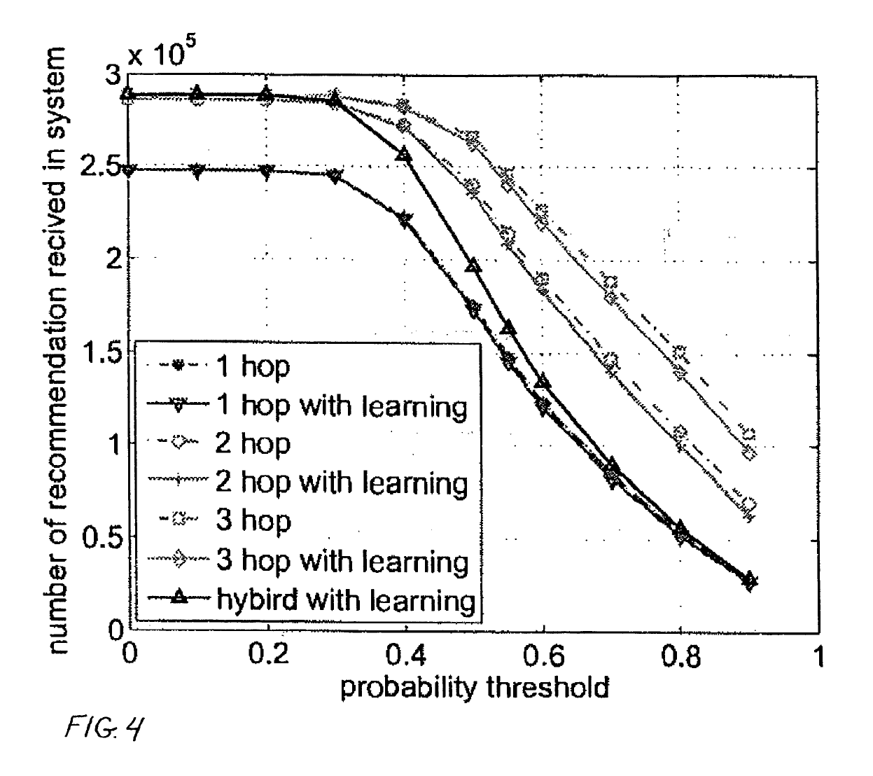

FIG. 4 depicts a graphical representation of the numbers of recommendations vs. probability threshold with different query range (e.g., TTL), with and without dynamic probability learning. The number of recommendations increases as the query range increases, and the dynamic learning does not have much impact on the number of recommendations. Larger query range gives querier better chance to encounter users who have already rated the movie, thus more recommendations. The number of recommendations decreases as the probability threshold increases. Intuitively, as the probability threshold increases, more and more Most Probable (MP) recommendations with low probability are filtered out. The number of recommendations does not fall much when the threshold is less than 0.3, thought, which indicates the majority of the recommendations have the probability greater than 0.3.

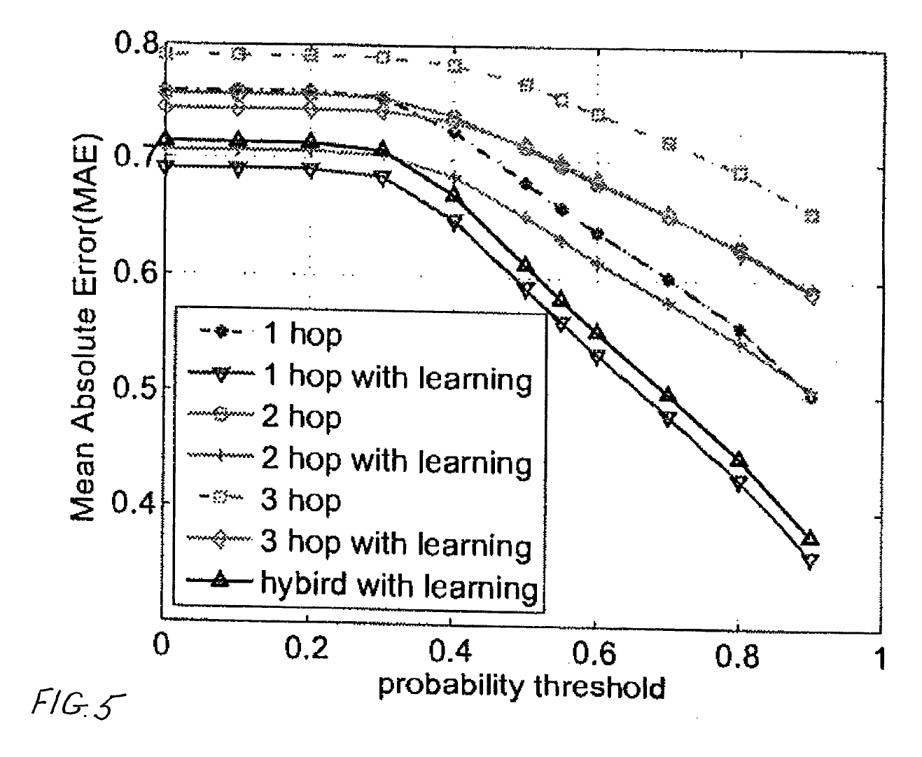

FIG. 5 depicts the recommendation accuracy, MAE, vs. probability threshold. The reduction of MAE is quite significant when the threshold is greater than 0.3. Thus setting the probability threshold properly can strike the right balance between the number of recommendations and the quality of recommendations. The improvement of MAE with dynamic learning is significant over non-dynamic learning, demonstrating the effectiveness of the probability learning. Finally, the recommendation quality decreases as the query range increases. It is believed that the closer friend offers higher quality recommendations.

Hybrid recommendation searching scheme: Note that the recommendation quality improves as the searching scope decreases. We thus propose the hybrid recommendation searching scheme. Hybrid recommendation searching scheme looks for the closest recommenders possible, and increases the searching scope only if no closer recommenders can be found. One simple way to implement this scheme is to start with TTL=1, and increases TTL by one only if no recommendation can be find in the previous round. The query process stops once a personalized recommendation is found.

FIGS. 4 and 5 depict the number of recommendations and MAE vs. different threshold for hybrid scheme with dynamic learning. Hybrid scheme generates the recommendations with MAE similar to 1-hop query yet the number of recommendations is greater than i-hop query.

Comparison with Collaborative Filtering

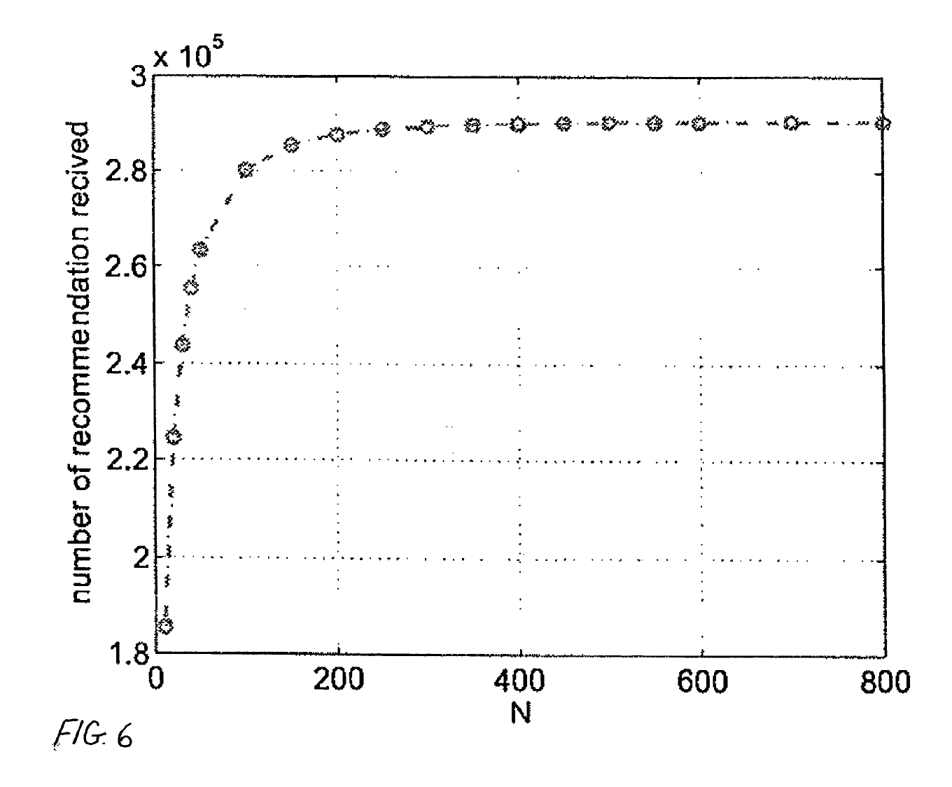

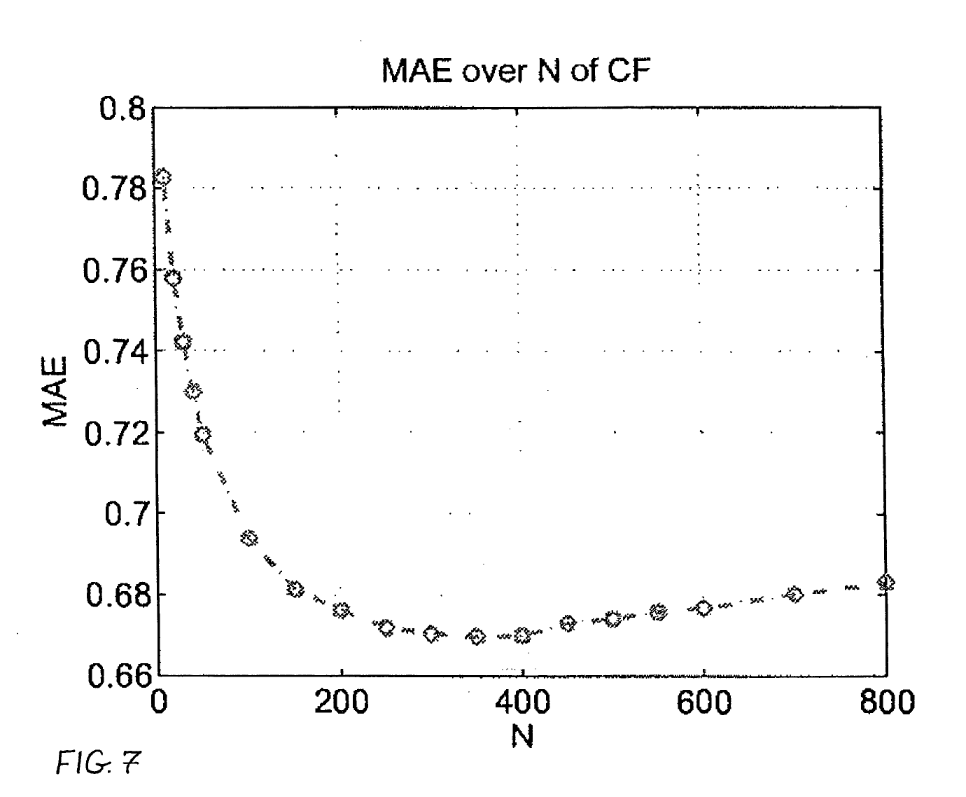

There are many CF algorithms. We use the user-to-user nearest neighbor prediction algorithm based on Pearson Correlation. The recommendation is based on N nearest neighbors, in terms of Pearson correlation, from the entire user population. The number of recommendations received is shown in FIG. 6, and MAE of CF is shown in FIG. 7. CF achieves the best performance at N=250, with about 290,000 recommendations and MAE of 0.67.

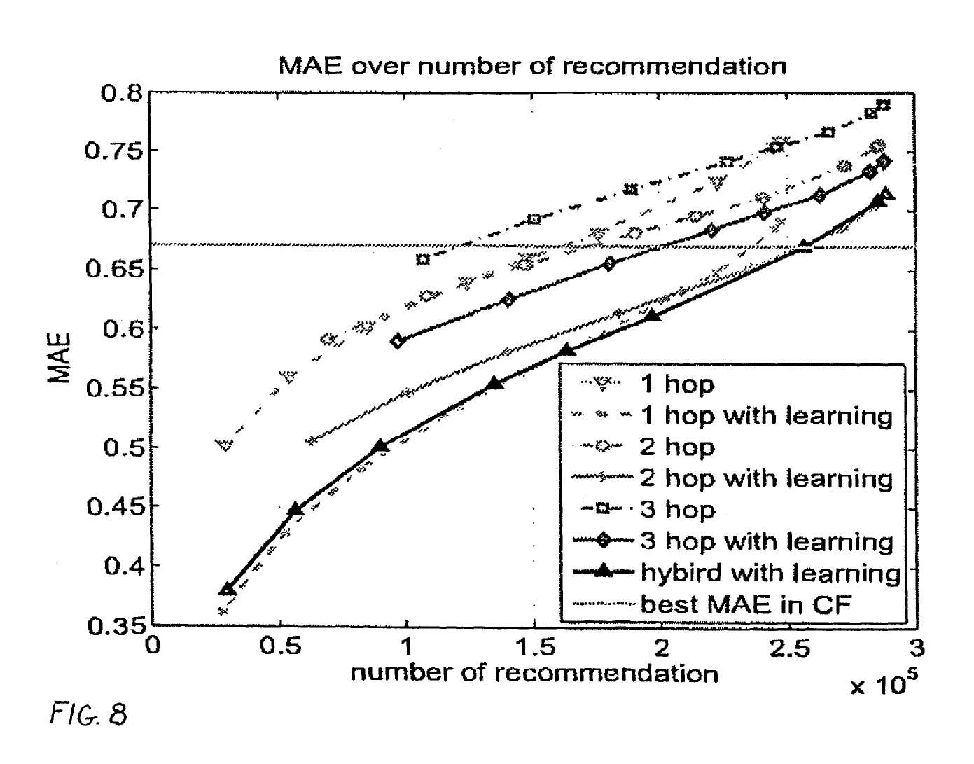

We can see from FIG. 8, by setting appropriate probability threshold, hybrid dynamic pull can reach the best MAE of CF while receiving about 256,000 recommendations, which means getting almost 90% of the total number of recommendations received by CF. And if we set the probability threshold larger, the system can give more precise recommendation than CF.

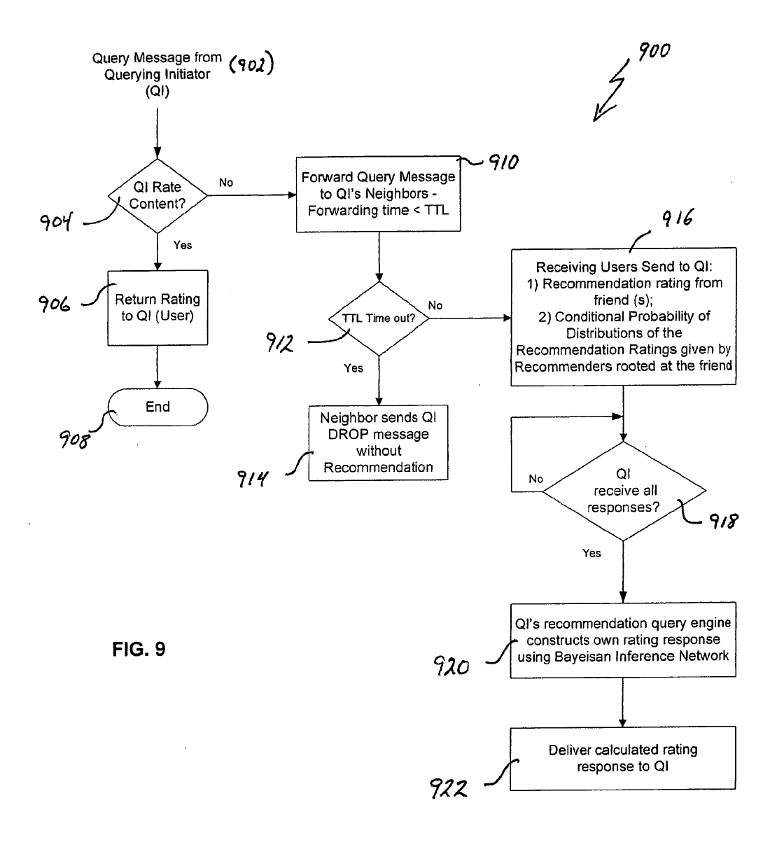

FIG. 9 show a flow diagram of the method 900 for providing recommendation in a social network. As described above a query message is sent from a user or querying initiator (QI) (902). Initially a determination is made whether the QI has rated the content (904) relating to the query message. If so, the rating is returned to the QI (906) and the process ends (908). In the event the QI did not rate the content the querying message is sent to QI's neighbors (910). Here, the system will generate the propagation tree (discussed above) and utilize the same for calculations relating to the conditional probabilities and marginal conditional probabilities used in determining the neighbor's ratings and the weighting of the same.

The forwarding of QI's query message (910) is performed for a predetermined period of time defined by TTL, and a determination is made whether the TTL has timed out at step 912. If the TTL has timed out, the neighbor sends the QI a DROP message without a recommendation (914). If the TTL has not timed out, the receiving users (i.e. QI's neighbors) send to the QI: 1) recommendation ratings from friends of neighbor; and 2) the conditional probability of distribution of the recommendation ratings given by recommenders rooted at the user's (i.e., QI's neighbors) friends (916). A determination is then made whether or not the QI has received all the responses (918). If not, the system loops to wait for all responses. If all responses have been received, QI's recommendation query engine constructs its own rating response using the Bayesian inference network (920). Once received, the user's recommendation query engine will deliver the calculated rating response to the QI (922).

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for providing recommendations in a social network; the method comprising the steps of
receiving a query message from a querying initiator for content rating;
forwarding said query message to QI's neighbors;
receiving recommendations ratings from QI's neighbors or neighbors' friends or both;
receiving conditional probability of distribution of recommendation ratings given by recommenders; and
constructing a QI rating response using a Bayesian Inference Network.

2. The method of claim 1, further comprising:
determining whether the QI has rated requested content previously in response to the received query message;
returning to the QI their rating when it has been determined the QI has previously rated the requested content; and
terminating query message from QI.

3. The method of claim 1, wherein said forwarding further comprises:
determining how long the query message should be forwarded to based on a time out period.

4. The method according to claim 1, wherein said receiving a query message comprises receiving a query message having a unique identifier.

5. The method of claim 3, wherein said determining how long the query message should be forwarded further comprises determining how many friend hops the query message should be sent.

6. The method of claim 1, wherein said forwarding further comprises:
determining whether a predetermined time out has expired; and
if said predetermined time out has expired, sending the QI a DROP message without a recommendation.

7. The method of claim 1, wherein said step of constructing a QI rating response using a Bayesian inference Network is performed using the received recommendations ratings from QI's neighbors r neighbors' friends or both and the received conditional probability of distribution of recommendation ratings given by recommenders.

8. The method of claim 1, wherein said forwarding further comprises constructing a propagation tree and determining from the constructed tree which of QI's neighbors' friends will receive the query message.

9. A computer program product comprising a computer useable medium having a computer readable program, wherein the computer readable program when executed on a computer causes the computer to perform method steps for providing recommendations in a social network, including:
receiving a query message from a querying initiator for content rating;
forwarding query message to QI's neighbors;
receiving recommendations ratings from QI's neighbors or neighbors' friends or both;
receiving conditional probability of distribution of recommendation ratings given by recommenders; and
constructing a QI rating response using a Bayesian Inference Network.

10. The computer program product as recited in claim 9, wherein the computer readable program when executed on a computer causes the computer to perform further method steps for providing recommendations in a social network, including:
determining whether the QI has rated requested content previously in response to the received query message;
returning to the QI their rating when it has been determined the QI has previously rated the requested content; and
terminating query message from QI.

11. The computer program product as recited in claim 9, wherein the computer readable program when executed on a computer causes the computer to perform further method steps for providing recommendations in a social network, wherein said forwarding further includes determining how long the query message should be forwarded to based on a time out period.

12. The computer program product as recited in claim 9, wherein the computer readable program when executed on a computer causes the computer to perform further method steps for providing recommendations in a social network, wherein said receiving a query message includes receiving a query message having a unique identifier.

13. The computer program product as recited in claim 11, wherein the computer readable program when executed on a computer causes the computer to perform further method steps for providing recommendations in a social network, wherein said determining how long the query message should be forwarded further includes determining how many friend hops the query message should he sent.

14. The computer program product as recited in claim 9, wherein the computer readable program when executed on a computer causes the computer to perform further method steps for providing recommendations in a social network, including
determining whether a predetermined time out has expired; and
if said predetermined time out has expired, sending the QI a DROP message without a recommendation.
